(19) United States
(12) Patent Application Publication
(10) Pub. No.: US 2020/0074217 A1
(43) Pub. Date: Mar. 5, 2020

(54) TECHNIQUES FOR PROVIDING USER NOTICE AND SELECTION OF DUPLICATE IMAGE PRUNING

(71) Applicant: Sony Corporation, Tokyo (JP)

(72) Inventor: Brant Candelore, Escondido, CA (US)

(21) Appl. No.: 16/114,672

(22) Filed: Aug. 28, 2018

(51) Int. Cl. G06K 9/62; G06K 9/46; G06K 9/00

(52) U.S. Cl. CPC G06K 9/6212; G06F 3/04842; G06K 9/00234; G06K 9/46

(57) ABSTRACT

A photograph is processed using signal image comparison to determine whether it is a substantial duplicate of another photo. The camera alerts the user when the photo just obtained is very similar to one that was previously taken, and then based on camera settings either offers to delete the picture from the camera's memory for the user or deletes automatically. The camera may determine whether two photos are nearly identical by a pixel by pixel comparison.

### FIELD

The present application relates to technically inventive, non-routine solutions that are necessarily rooted in computer technology and that produce concrete technical improvements.

### BACKGROUND

Many cameras come in small packages with small screens. Such cameras may still be able to render high solution images, but as understood herein, it can be difficult to see images on the screen in bright light (in the sun) and because the camera images on the screen are too small.

### SUMMARY

As understood here, photography can be complicated when, for example, a user takes multiple photographs in quick succession in an effort to capture a “good” photo, e.g., to make sure that the focus is correct, that people had their eyes open, that people are smiling, that there is no smudge on the picture, etc. These duplicative photographs take up space on the memory card of the camera and later must be reviewed by the user and then deleted. People try to look at each photo to see if it is OK, but it is difficult to do in difficult lighting situations. While there may be subtle differences between photos that a human might find of interest, in many cases the photos are almost identical with no perceptible differences at least to the human eye.

Present principles recognize the above problems and so provide an assembly with a housing. At least one processor is in the housing, and at least one imager is supported on the housing and is configured to communicate with the processor. At least one computer storage also is in the housing and includes instructions executable by the processor to receive a first photograph, and to compare the first photograph to at least one earlier photograph to determine whether the first photograph is a substantial duplicate of the earlier photograph. The instructions are executable to, responsive to determining that the first photograph is a substantial duplicate of the earlier photograph, present on the assembly at least one user interface (UI) indicating that the first photograph is a substantial duplicate of the earlier photograph.

In some examples, the instructions can be executable to select the earlier photograph based on the earlier photograph having been generated within a time period prior to generation of the first photograph. The earlier photographs are not selected for comparison with the first photograph if it was generated outside of the time period.

In non-limiting implementations, the instructions can be executable to compare, on a pixel-by-pixel basis, the first photograph to the earlier photograph to determine whether the first photograph is a substantial duplicate of the earlier photograph. This comparison may include comparing each pixel in the first photograph to a same pixel location in a grid of pixels of the earlier photograph. A difference between pixel values may be determined for each pixel-to-pixel comparison and in some examples the cumulative differences between all corresponding pixel values are compared to a test value, and based on the comparison meeting a first criterion, “duplicate photo” is indicated. Or, differences between all corresponding pixel values may be averaged and compared to a test value, and based on the comparison meeting a first criterion, “duplicate photo” can be indicated. Yet again, differences between all corresponding pixel values can be squared and then divided by a sum of the squares of individual pixel differences to determine whether the photographs are duplicates.

In some implementations, a subset of pixels in the first photograph is identified, and only the subset is compared to the earlier photograph to determine whether the photos are duplicates. Pixels outside the subset and not compared. The subset may be identified based at least in part on corresponding to an image of a human face, and/or based on having a histogram satisfying a criterion, and/or based on being center-most pixels in the first photograph, and/or based on being pixels that are in-focus.

The UI can visually indicate that the first photograph is a substantial duplicate of the earlier photograph. In addition, or alternatively, the UI audibly indicates that the first photograph is a substantial duplicate of the earlier photograph. In addition, or alternatively, the UI tactilely indicates that the first photograph is a substantial duplicate of the earlier photograph.

In another aspect, a computer storage device that is not a transitory signal includes instructions executable by at least one processor to present on at least one computer display at least one user interface (UI). The UI includes at least a first image representing a first photograph and at least a second image representing a second photograph taken within a few seconds to the first photograph and determined to be a duplicate of the first photograph. Depending on a setting, the user is notified, and the second image can either be deleted or saved by the user or deleted automatically. If the user deletes the second image, the user may optionally be allowed to delete the first image. Input to delete or save the image by the user or delete the image automatically is receivable from the UI by the at least one processor.

In another aspect, a method includes receiving a first photograph, and comparing the first photograph to at least one earlier photograph at least in part based on the earlier image having been taken in a most recent period prior to taking the first photograph. The method also includes determining whether the first photograph is a substantial duplicate of the earlier photograph. Responsive to determining that the first photograph is a substantial duplicate of the earlier photograph, depending a setting, either a UI is presented on a display permitting a user to delete at least one of the photographs or the duplicate is deleted automatically.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 is a view of a camera implemented as a standalone device;

FIG. 3 is a view of a camera implemented as a mobile telephone;

FIG. 4 is a flow chart of example logic of a first embodiment consistent with present principles;

FIG. 5 is a flow chart of example logic of a second embodiment consistent with present principles; and

FIG. 6 is a screen shot of an example user interface (UI) consistent with present principles.

### DETAILED DESCRIPTION

This disclosure relates generally to computer ecosystems including aspects of consumer electronics (CE) device-based user information in computer ecosystems. A system herein may include server and client components, connected over a network such that data may be exchanged between the client and server components. The client components may include one or more computing devices including imaging devices such as standalone digital cameras and cameras in mobile telephones, alone or in conjunction with portable televisions (e.g. smart TVs, Internet-enabled TVs), portable computers such as laptops and tablet computers, and other mobile devices. These client devices may operate with a variety of operating environments. For example, some of the client computers may employ, as examples, operating systems from Microsoft, or a Unix operating system, or operating systems produced by Apple, Inc. or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments an appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

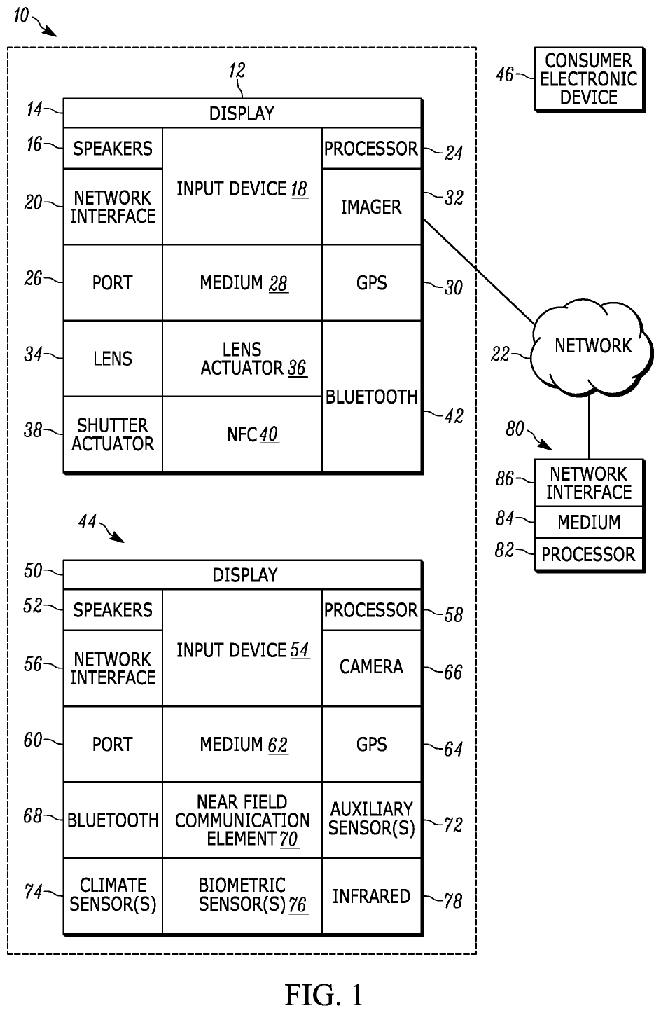

Now specifically referring to FIG. 1, an example ecosystem 10 is shown, which may include one or more of the example devices mentioned above and described further below in accordance with present principles. The first of the example devices included in the system 10 is an example imaging device (ID) 12 that may be a standalone imaging device, or an imaging device incorporated in another apparatus such as a mobile telephone, mobile computer, etc. Regardless, it is to be understood that the ID 12 is configured to undertake present principles (e.g. communicate with other CE devices to undertake present principles, execute the logic described herein, and perform any other functions and/or operations described herein).

Accordingly, to undertake such principles the ID 12 can be established by some or all of the components shown in FIG. 1. For example, the ID 12 can include one or more displays 14 that may be touch-enabled for receiving consumer input signals via touches on the display. The ID 12 may include one or more speakers 16 for outputting audio in accordance with present principles, and at least one additional input device 18 such as e.g. an audio receiver/microphone for e.g. entering audible commands to the ID 12 to control the ID 12, control keys for entering commands and/or data, etc. The example ID 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. The one or more interfaces 20 may include a wireless telephony transceiver such as but not limited to global systems for communication (GSM) transceiver, a code division multiple access (CDMA) transceiver including w-CDMA, an orthogonal frequency division multiplex (OFDM) transceiver, etc.

It is to be understood that the processor 24 controls the ID 12 to undertake present principles, including the other elements of the ID 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the ID 12 may also include one or more input ports 26 such as, e.g., a USB port to physically connect using a wired connection) to another CE device and/or a headphone port to connect headphones to the ID 12 for presentation of audio from the ID 12 to a consumer through the headphones. The ID 12 may further include one or more computer memories 28 that are not transitory signals, such as disk-based or solid-state storage (including but not limited to flash memory). Also, in some embodiments, the ID 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the ID 12 is disposed in conjunction with the processor 24. However, it is to be understood that that another suitable position receiver other than a cellphone receiver, GPS receiver and/or altimeter may be used in accordance with present principles to e.g. determine the location of the ID 12 in e.g. all three dimensions.

Continuing the description of the ID 12, in some embodiments the ID 12 may include one or more imagers 32 that may he, e.g., a thermal imaging camera, a digital camera such as a webcam, and/or a camera integrated into the ID 12 and controllable by the processor 24 to gather pictures/images and/or video in accordance with present principles. An imager may he implemented by, without limitation, a charge-coupled device (CCD) or complementary metal-oxide-semiconductor (CMOS) device.

Light from objects may enter the imager 32 through one or more lenses 34. The lens 34 may be movable by a lens actuator 36 to focus the image on the imager 32. Without limitation, the imager 32 with lens 34 may be implemented in a digital single lens reflex (DSLR) package.

One or more shutter actuators 38 may be provided on the ID 12. The shutter actuator 38 can be manipulated to cause a shutter to open or otherwise “take” a picture. The shutter actuator may be implemented by s hardware key or soft key.

Also included on the ID 12 may be a Bluetooth transceiver 42 and other Near Field Communication (NFC) element 40 for communication with other devices using Bluetooth and/or NFC technology, respectively. An example NFC element can be a radio frequency identification (RFID) element. A battery (not shown) may be provided for powering the 12.

Still referring to FIG. 1, in addition to the ID 12, the system 10 may include one or more other CE device types. In one example, a first CE device 44 may be used to exchange photographic and video information with the ID 12 and/or with the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network.

The example non-limiting first CE device 44 may be established by any one of the above-mentioned devices, for example, an internet-enabled TV, a portable wireless laptop computer or tablet computer or notebook computer, and accordingly may have one or more of the components described below. The first CE device 44 alternatively may be embodied in the form of eyeglasses or a wireless telephone. The second CE device 46 without limitation may be established by a wireless telephone. The second CE device 46 may implement a portable hand-held remote control (RC).

The first CE device 44 may include one or more displays 50 that may be touch-enabled for receiving consumer input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 may control the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device such as the ID 12 and/or a headphone port to connect headphones to the first CE device 44 for presentation of audio from the first CE device 44 to a consumer through the headphones. The first CE device 44 may further include one or more computer memories 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, sing triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44.

The second CE device 46 may include some or all of the components shown for the CE device 44.

Now in reference to the afore-mentioned at least one server 80, it includes at least one server processor 82, at least one computer memory 84 such as disk-based or solid-state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

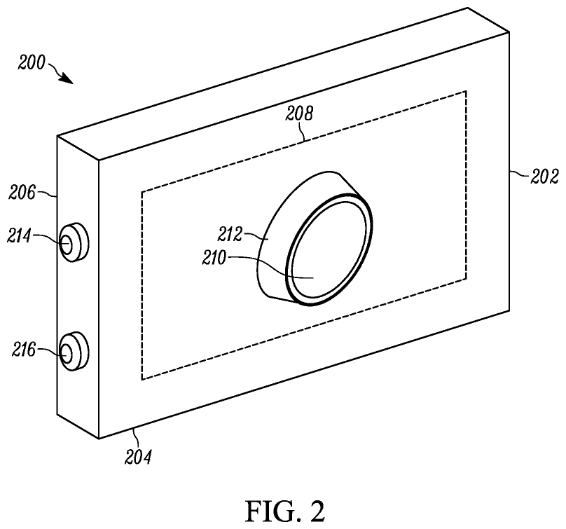

FIG. 2 illustrates a first example implementation of the ID 12, showing a standalone camera device 200 with a housing 202 containing components described above and having a front 204 and a back 206 (relative to the user, with the back 206 facing the user when in use to take pictures). A display 208 (shown in phantom in FIG. 2) may be part of the back 206 of the camera device 200. The display 208 can resent images as generated by the imager within the housing 202.

As shown in FIG. 2, the camera device 200 may include a lens 210 that may be moved be a lens actuator 212 to focus the image on the imager behind the lens (not shown). In the example of FIG. 2. a shutter actuator button 214 is on the housing 202 and can be manipulated to capture an image to “take a picture” as a digital photograph. If desired, one or more lamps 216 such as light emitting diodes (LEDs) or other lamps may be provided.

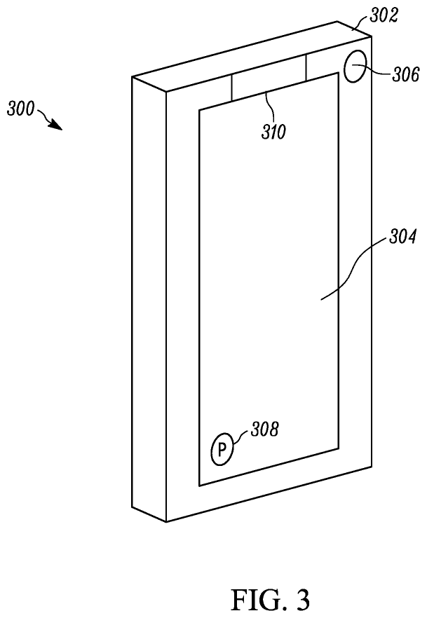

FIG. 3 illustrates a second example implementation of the ID 12, implemented as a mobile telephone 300 with a housing 302 containing components described above. A display 304 is on the housing 302 to present images as generated by the imager within the housing 302. A lens 306 is provided to focus the image on the imager behind the lens (not shown). The display 304 may be touch-enabled and may present a soft shutter actuator 308 that can be manipulated to capture an image to “take a picture” as a digital photograph. If desired, one or more lamps 310 such as light emitting diodes (LEDs) or other lamps may be provided, in the example shown, behind a bezel or display but visible therethrough. The LEDs described herein may be multi-colored to illuminate in one of multiple available colors such as green, red, and blue wider command of the processor of the device.

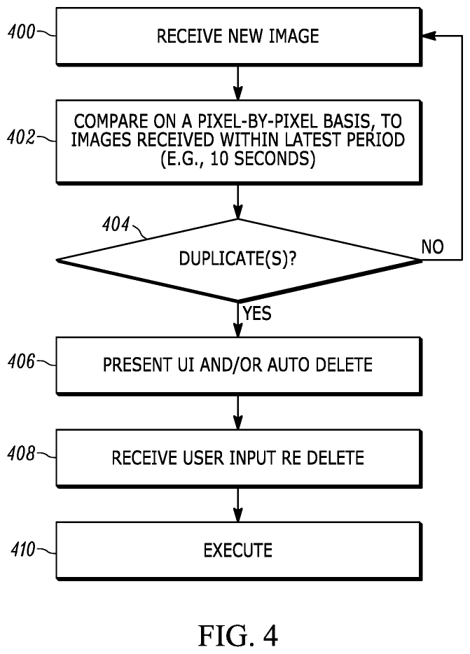

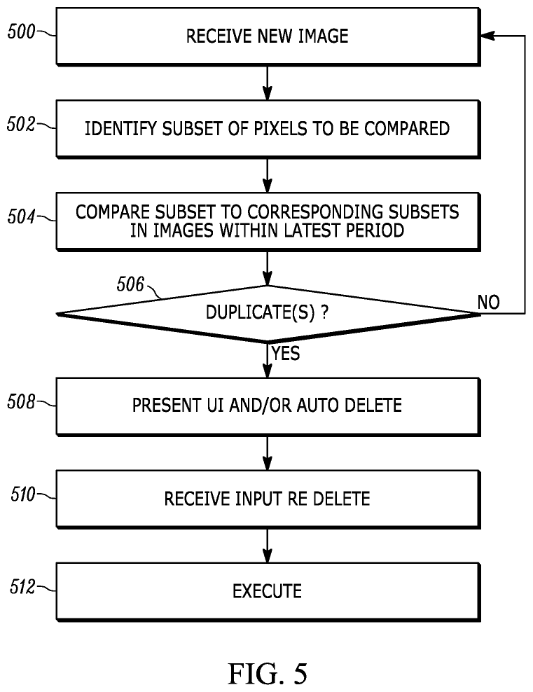

FIGS. 4 and 5 show logic that may be executed by any of the imaging devices described herein locally and/or in connection with offloading information to the server 80 for analysis and return of output information. Commencing at block 400 in FIG. 4, a new photo is received as indicated by, e.g., operation of the shutter mechanism of the camera. Moving to block 402, the new photo can be compared on a pixel-by-pixel basis with other photos already taken by the same camera and typically stored on the local data storage of the camera. In examples, the comparison may be executed only against earlier photos that have timestamps or other metadata indicating that they were taken in a most recent period, for example, within the last ten seconds prior to taking the photo under test, as photos taken outside the most recent period are less likely to be duplicates than photos taken within the most recent period.

In executing a pixel-by-pixel comparison, each pixel in the photo under test may be compared to the same pixel location in a grid of pixels of a prior photo and the difference between pixel values determined. The cumulative differences between all corresponding pixels may be summed and compared to a test value, and if the cumulative differences are less than the test value, the output of decision diamond 404 can indicate “duplicate photo”, to cause the logic to flow to block 406. On the other hand, if the cumulative differences are not less than the test value, the output of decision diamond 404 can indicate “not a duplicate photo”, to cause the logic to loop back to block 400 to receive another photo under test (or to compare the current photo under test with another prior photograph if any remain untested from block 402).

Or, other operations may be performed to compare pixels. For example, the differences between pixel values may be averaged and compared to a test average, or the differences may be squared and then divided by a sum of the squares of individual pixel differences and compared to a test value. These are but examples of techniques to compare pixels in two photographs to determine whether any substantially duplicate photographs have been taken.

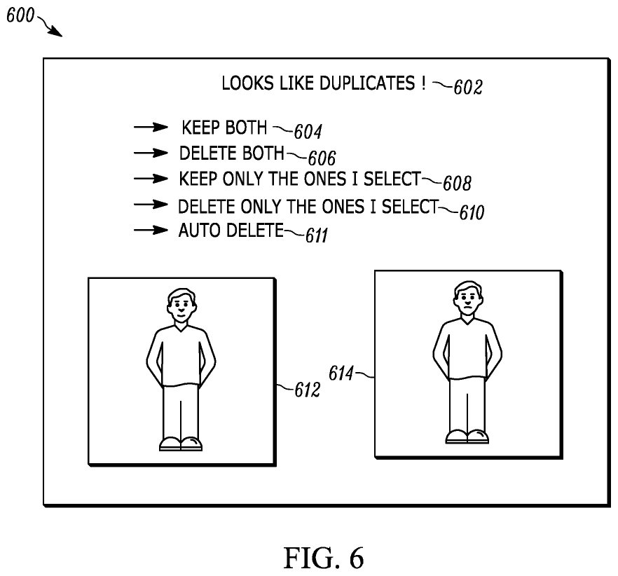

At block 406, a user interface (UI) may be presented on a display of the camera to inform the user of potential duplicate photographs and to afford the user the option of deleting duplicates or retaining them, as the user may wish to retain seemingly duplicate photographs owing to small differences between them that are nonetheless important to the user. An example UI is shown in FIG. 6 and discussed further below. In addition, or alternatively, the second photo (or if desired first photo) may automatically be deleted. Input is received from the UI at block 408 and the indicated actions (retain, delete, etc.) are executed at block 410.

FIG. 5 illustrates an alternate embodiment in which at block 500 a new photo is received as indicated by, e.g., operation of the shutter mechanism of the camera. Moving to block 502, to reduce the number of pixels that are to be compared, a subset of pixels may be identified in the photo received at block 500 to corresponding pixels in substantially the same pixel locations of a gird of pixels in prior photographs.

In example implementations, the subset of pixels may be identified as those establishing an image of a human face, as indicated by, e.g., image recognition of an image shape in the photograph corresponding to the shape of a human head, or as indicated by image recognition indicating facial features such as human eyes. In another embodiment, the subset of pixels to be analyzed may be identified based on a histogram indicating that the subset has a higher variance in pixel values exceeding a threshold. In other embodiments, the center-most pixels in the photo are identified as the subset to be compared against prior photographs. In other embodiments, the subset of pixels may be identified as being those pixels in images within the photograph that are in-focus. Other heuristics may be used for selecting the subset.

Moving to block 504, the subset of pixels from block 502 of the new photograph can be compared with other photos already taken by the same camera and typically stored on the local data storage of the camera. In examples, the comparison may be executed only against the corresponding subsets of pixels of earlier photos that have timestamps or other metadata indicating that they were taken in a most recent period, for example, within the last ten seconds prior to taking the photo under test, as photos taken outside the most recent period are less likely to be duplicates than photos taken within the most recent period. This may be done using a pixel-by-pixel comparison between subsets of pixels under test according to principles above, with pixels outside the subset identified at block 502 not being tested.

If a photo under test at block 504 is determined to be a substantial duplicate of an earlier photo at decision diamond 506, the logic moves block 508. On the other hand, if the output of decision diamond 506 is negative the logic can loop back to block 500 to receive another photo under test (or to compare the current photo under test with another prior photograph if any remain untested from block 504).

At block 508, a UI may be presented on a display of the camera to inform the user of potential duplicate photographs and to afford the user the option of deleting duplicates or retaining them, as the user may wish to retain seemingly duplicate photographs owing to small differences between them that are nonetheless important to the user. An example UI is shown in FIG. 6 and discussed further below. Input is received from the UI at block 510 and the indicated actions (retain, delete, etc.) are executed at block 512. In addition, or alternatively, the second photo (or if desired first photo) may automatically be deleted.

FIG. 6 illustrates an example UI 600 that may be presented on any of the displays herein, including the displays of any of the camera devices consistent with present principles. A prompt 602 may be presented informing the user that duplicate photos may potentially be stored, e.g., on local storage and thus may be amenable to pruning. The prompt 602 may be visual and/or audible and/or tactile.

The UI 600 may include one or more selectors such as one or more of the example selectors shown and discussed now. For example, the UI 600 may include a selector 604 to keep both (or all, if more than two) potentially duplicate photos. A selector 606 may be provided to delete both (or all, if more than two) potentially duplicate photos. A selector 608 may be provided to keep only photos selected by the user from, e.g., a list, or by touching presentations of the photos as will be described shortly. Yet again, a selector 610 may be provided to delete only photos selected by the user from, e.g., a list, or by touching presentations of the photos as will be described shortly. A selector 611 also may be provided that, if selected, causes the processor to automatically delete the earlier photo or the later photo as set by the manufacturer or as modified by the user.

Indeed, in the example shown in FIG. 6, the UI 600 includes representations 612, 614 of the potentially duplicate photos. When more than two potentially duplicate photos exist, more than two representations may be presented or the left-most (for example) representation 612 may represent the photo under test and the right-most representation 614 may represent one of the plural other potentially duplicate photos, and the user can swipe through the other plural photos by a swipe gesture or other appropriate gesture on the right-most representation 614. A tap or double tap or other gesture may be used on a representation of a photo to delete that photo from local storage and/or to upload it to a server without further user interaction. Equivalently, as indicated above a photo may be selected to command the camera to keep that photo in local storage.

While particular techniques are herein shown and described in detail, it is to he understood that the subject matter which is encompassed by the present application is limited only by the claims.

What is claimed is:

1. An assembly, comprising:
a housing;
at least one processor in the housing;
at least one imager supported on the housing and configured to communicate with the processor;
at least one computer storage in the housing and comprising instructions executable by the processor to:
receive a first photograph;
compare the first photograph to at least one earlier photograph to determine whether the first photograph is a substantial duplicate of the at least one earlier photograph; and
responsive to determining that the first photograph is a substantial duplicate of the at least one earlier photograph perform at least one of the following: present on the assembly at least one user interface (UI) indicating that the first photograph is a substantial duplicate of the at least one earlier photograph, automatically delete the first photograph

2. The assembly of claim 1, wherein the instructions are executable to:
select the at least one earlier photograph based on the at least one earlier photograph having been generated within a time period prior to generation of the first photograph, and not select earlier photographs for comparison with the first photograph that were generated outside of the time period.

3. The assembly of claim 1, wherein the instructions are executable to:
compare, on a pixel-by-pixel basis, the first photograph to at least one earlier photograph to determine whether the first photograph is a substantial duplicate of the at least one earlier photograph.

4. The assembly of claim 3, wherein a pixel-by-pixel comparison to determine whether the first photograph is a substantial duplicate of the at least one earlier photograph comprises comparing each pixel in the first photograph to a same pixel location in a grid of pixels of the at least one earlier photograph.

5. The assembly of claim 4, wherein the instructions are executable to:
determine for each pixel-to-pixel comparison a difference between pixel values.

6. The assembly of claim 5, wherein the instructions are executable to compare cumulative differences between all corresponding pixel values to a test value, and based on the comparison meeting a first criterion, indicate “duplicate photo”.

7. The assembly of claim 5, Wherein the instructions are executable to average differences between all corresponding pixel values and compare the average to a test value, and based on the comparison meeting a first criterion, indicate “duplicate photo”.

8. The assembly of claim 5, wherein the instructions are executable to square differences between all corresponding pixel values and divide by a sum of the squares of individual pixel differences.

9. The assembly of claim 1, wherein the instructions are executable to:
identify a subset of pixels in the first photograph; and
compare only the subset to the at least earlier photograph and not compare pixels in the first image outside the subset to the at least earlier photograph.

10. The assembly of claim 9, wherein the subset is identified based at least in part on corresponding to an image of a human face.

11. The assembly of claim 9, wherein the subset is identified based at least in part on having a histogram satisfying a criterion.

12. The assembly of claim 9, wherein the subset is identified based at least in part on being center-most pixels in the first photograph.

13. The assembly of claim 9, wherein the subset is identified based at least in part on being pixels that are in-focus.

14. The assembly of claim 1, wherein the UI visually indicates that the first photograph is a substantial duplicate of the at least one earlier photograph.

15. The assembly of claim 1, wherein the UI audibly indicates that the first photograph is a substantial duplicate of the at least one earlier photograph.

16. The assembly of claim 1, wherein the instructions are executable to:
responsive to determining that the first photograph is a substantial duplicate of the at least one earlier photograph perform at least one of the following: present on the assembly the at least one UI indicating that the first photograph is a substantial duplicate of the at least one earlier photograph.

17. A computer storage device that is not a transitory signal and that comprises instructions executable by at least one processor to:
present on at least one computer display at least one user interface (UI) comprising:
at least a first image representing a first photograph; and
at least a second image representing a second photograph taken prior to the first photograph and determined to be a potential duplicate of the first photograph, input to save or delete one or both of the first and second photographs being receivable from the UI by the at least one processor.

18. The computer storage device of claim 17, wherein the second photograph is selected based at least in part as having been taken within a period prior to taking the first photograph, such that the second photograph is not presented responsive to being taken outside the period.

19. The computer storage device of claim 17, wherein the device is implemented in a camera.

20. A method, comprising:
receiving a first photograph;
comparing the first photograph to at least one earlier photograph at least in part based on the at least one earlier image having been taken in a most recent period prior to taking the first photograph;
determining whether the first photograph is a substantial duplicate of the at least one earlier photograph, and
responsive to determining that the first photograph is a substantial duplicate of the at least one earlier photograph presenting on a display at least one user interface (UI) permitting a user to delete at least one of the photographs.
